(19) United States
(12) Patent Application Publication
(10) Pub. No.: US 2010/0127953 A1
(43) Pub. Date: May 27, 2010

(54) ANTENNA, ANTENNA ARRANGEMENT AND RADIO COMMUNICATION APPARATUS

(75) Inventor: Daniel WIK, Lidingo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/277,406

(22) Filed: Nov. 25, 2008

(51) Int. Cl. H01Q 1/36

(52) U.S. Cl. 343/899

(57) ABSTRACT

An antenna is disclosed. The antenna comprises a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage. An antenna arrangement and a radio communication apparatus are also disclosed.

### TECHNICAL FIELD

The present invention relates to an antenna, an antenna arrangement with such an antenna, and a radio communication apparatus with such an antenna arrangement.

### BACKGROUND

Antenna characteristics are very much depending on geometrical properties, such as position and form of antenna elements, position of feeding, and position and form of parasitic elements, which can be both intended and unintended. By changing any of these properties, the antenna characteristics can be tuned such that the antenna works as intended. This is normally done when designing the antenna, or by switching in and out antenna elements and/or parasitic elements. However, there is a desire to provide a less complex way of after-design tuning of an antenna.

### SUMMARY

The present invention is based on the understanding that an electroactive polymer can be arranged to change its form when applying a suitable voltage across it. The inventor has found that by applying antenna elements on mutual sides of an electroactive polymer element, geometrical properties of these can be changed by applying a voltage across the electroactive polymer element.

According to a first aspect, there is provided an antenna comprising a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

At least one of the first and second antenna element may be a conductive coating on the electroactive polymer element.

The antenna may be a planar inverted F antenna. The antenna may further have capacitive feeding.

At least one of the first and the second antenna element may be fed via a spring contact such that feeding is ensured upon the adjustment of position of the antenna element.

According to a second aspect, there is provided an antenna arrangement comprising an antenna comprising a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

The antenna arrangement may further comprise a controller arranged to provide the voltage based on a received tuning parameter.

According to a third aspect, there is provided a radio communication apparatus comprising an antenna arrangement comprising an antenna comprising a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

The communication apparatus may further comprise a controller arranged to provide the voltage based on a received tuning parameter. The tuning parameter may be provided by a radio circuitry of the communication apparatus.

### BRIEF DESCRIPTION OF DRAWINGS

FIGS. 1a and 1b are sectional views of an antenna according to an embodiment in different operation states.

FIGS. 2a and 2b are sectional views illustrating an antenna according to an embodiment in different operation states.

FIG. 3 schematically illustrates an antenna arrangement according to an embodiment.

FIG. 4 schematically illustrates a radio communication apparatus according to an embodiment.

### DETAILED DESCRIPTION

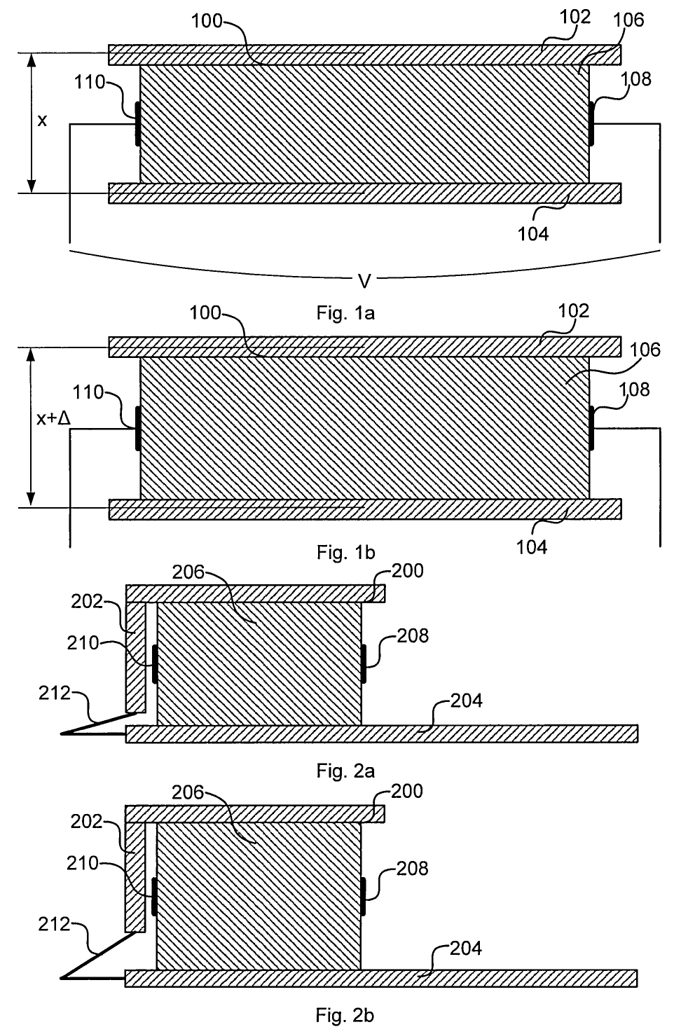

FIGS. 1a and 1b are sectional views of an antenna 100 according to an embodiment in different operation states. The antenna 100 comprises a first antenna element 102, a second antenna element 104, and an electroactive polymer element 106 arranged between the first and the second antenna elements 102, 104. The electroactive polymer element 106 has electrodes 108, 110 arranged on mutual sides such that a voltage V can be applied across the electroactive polymer element 106. Upon application of the voltage, the electroactive polymer changes size and applies a force on the antenna elements 102, 104 such that they are displaced, as illustrated in FIG. 1b. Thus, geometry and characteristics of the antenna is changed by applying suitable voltage between the electrodes 108, 110, and thus across the electroactive polymer.

FIGS. 2 are sectional views illustrating an antenna 200 according to an embodiment. The antenna 200 is a planar inverted F antenna. The antenna 200 comprises a first antenna element 202, a second antenna element 204, and an electroactive polymer element 206 arranged between the first and the second antenna elements 202, 204. The electroactive polymer element 206 has electrodes 208, 210 arranged on mutual sides such that a voltage can be applied across the electroactive polymer element 206. Upon application of the voltage, the electroactive polymer changes size and applies a force on the antenna elements 202, 204 such that they are displaced. Thus, geometry and characteristics of the antenna is changed by applying suitable voltage between the electrodes 208, 210, and thus across the electroactive polymer. A spring contact 212 is arranged to feed the antenna elements 202, 204. This provided for proper feeding although the antenna elements 202, 204 are displaced, as illustrated in FIG. 2b. Such a spring contact 212 is also suitable for other embodiments for providing proper feeding to displaced antenna elements.

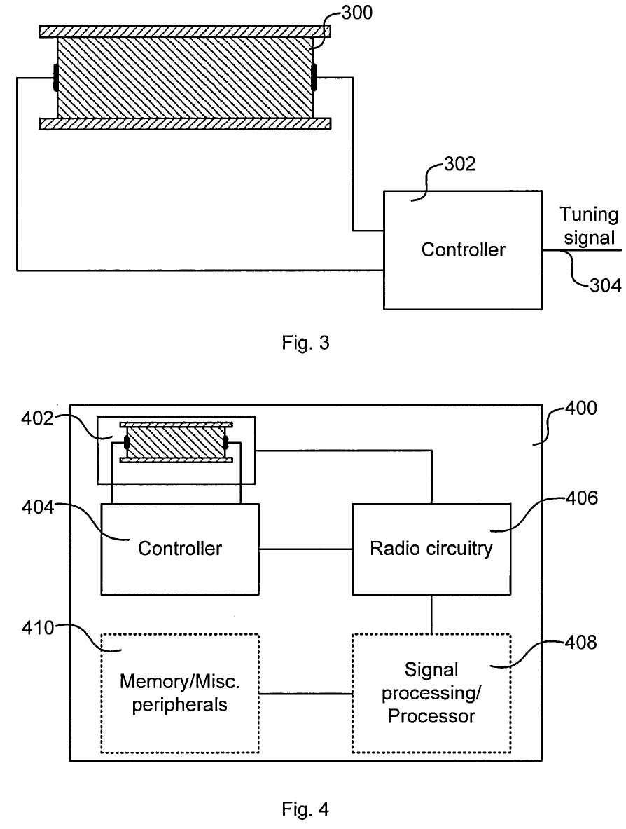

FIG. 3 schematically illustrates an antenna arrangement according to an embodiment. The antenna arrangement comprises an antenna 300 having displacable antenna elements by an electroactive polymer element, e.g. according to any of the embodiments demonstrated above with reference to FIGS. 1 and 2. A voltage is provided across the electroactive polymer element by a controller 302, which provides the voltage based on a received tuning signal 304. Thereby, the antenna 300 can be tuned for desired properties.

FIG. 4 schematically illustrates a radio communication apparatus 400 according to an embodiment. The radio communication apparatus 400 comprises an antenna 402 having at least one of its antenna elements displaceable such that its distance to the other antenna element is adjustable, as demonstrated above, by an electroactive polymer element. This is performed by provision of a voltage across the electroactive polymer element, where the voltage is provided by a controller 404. The controller 404 can provide this voltage based on a tuning signal that can be provided by a radio circuitry 406. The radio circuitry 406 is arranged to send and/or transmit via the antenna 402. Optionally, signal processing means 408, which can be a general processor or dedicated signal processing circuitry, is connected to the radio circuitry for provision of signals to the radio circuitry for transmission, reception of received and demodulated signals, and/or provision of control signals to the radio circuitry. Optionally, the tuning signal is provided by the signal processing means 408 instead of the radio circuitry 406. The tuning signal can be used to adjust center frequency, directional properties, impedance, etc. of the antenna 402. Further elements 410, such as memory, user interface, interfaces, etc. can be connected to the signal processing means 408.

1. An antenna comprising
a first antenna element;
a second antenna element arranged along the first antenna element; and
an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

2. The antenna according to claim 1, wherein at least one of the first and second antenna element is a conductive coating on the electroactive polymer element.

3. The antenna according to claim 1, being a planar inverted F antenna.

4. The antenna according to claim 3, further having capacitive feeding.

5. The antenna according to claim 1, wherein at least one of the first and the second antenna element is fed via a spring contact such that feeding is ensured upon the adjustment of position of the antenna elements.

6. An antenna arrangement comprising an antenna comprising a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

7. The antenna arrangement according to claim 6, further comprising a controller arranged to provide the voltage based on a received tuning parameter.

8. A radio communication apparatus comprising an antenna arrangement comprising an antenna comprising a first antenna element; a second antenna element arranged along the first antenna element; and an electroactive polymer element arranged between the first and the second antenna elements, wherein the electroactive polymer element is connected to electrodes through which a voltage is applicable across the electroactive polymer element such that the distance between the first and the second antenna elements is adjustable by changing the voltage.

9. The radio communication apparatus according to claim 8, further comprising a controller arranged to provide the voltage based on a received tuning parameter.

10. The radio communication apparatus according to claim 9, wherein the tuning parameter is provided by a radio circuitry of the communication apparatus.
